(19) United States
(12) Patent Application Publication
(10) Pub. No.: US 2023/0193081 A1
(43) Pub. Date: Jun. 22, 2023

(54) SYSTEM AND METHOD FOR SEAMS IN RESILIENT SURFACE COVERING

(71) Applicant: AHF, LLC d/b/a AHF Products, Mountville, PA (US)

(72) Inventors: Olga L. Rivas, Mount Joy, PA (US); Kristy L. Gething, York, PA (US)

(21) Appl. No.: 17/925,925

(22) PCT Filed: May 20, 2021
(86) PCT No.: PCT/US2021/033509

§ 371 Date: Nov. 17, 2022

Related U.S. Application Data
(60) Provisional application No. 63/027,938, filed on May 20, 2020.

(51) Int. Cl. C09J 4/00; C09J 133/08; E04F 15/02; E04F 15/16

(52) U.S. Cl. CPC C09J 4/00; C09J 133/08; E04F 15/02016; E04F 15/163; C09J 2203/346; E04F 21/22

(57) ABSTRACT

Included are methods for sealing seams of resilient surface covering including the application of a curable composition at a seam and applying radiation to the curable composition. The radiation may be any suitable source such as UV or visible light.

### BACKGROUND OF THE INVENTION

### Field of the Invention

A method for sealing seams of resilient surface covering is included. The method includes the application of a curable composition at a seam followed by application of radiation. A kit including the components necessary to complete this method is also included.

### Summary of Related Art

Resilient surface coverings such as sheet, tile, and other forms include seams where adjacent sheet or tile is installed. These seams can permit liquid to flow from the top surface of the covering to the base such as a wall or subfloor. This causes challenges and potential floor failure during maintenance such as wet mopping and disinfection of the walking surface.

This has been resolved previously by including hot weld systems and cold weld systems. These weld systems serve as a sealer to prevent liquids and moisture from being transmitted from top surface to a base surface or vice versa.

Adhesives may bond, but do not provide a waterproof system.

### SUMMARY OF THE INVENTION

The hot weld and cold weld systems have some limitations. While these can successfully seal the seams, as required, the installation process is prolonged. For example, the heat weld system cannot be applied until several hours after the floor covering has been installed; 10 hours for heat weld—8-12 hours for cold weld. . Similarly, the cold weld systems require an extensive drying time.

What is needed is a sealing solution that can be applied immediately. Such a system will provide a cost-effective solution that permits undelayed, continuous installation of a wall or floor covering that reduces overall installation time while providing a waterproof seal and installed surface covering that meets industry needs.

Some embodiments herein provide a method for sealing seams of resilient surface covering including applying a curable composition at a seam and applying radiation to the curable composition. The surface covering may be a floor or wall covering.

### DETAILED DESCRIPTION OF THE INVENTION

### Description of Surface Coverings

A variety of different surface coverings may be used with the sealing system. The surface coverings may be applied to floors or walls. Suitable examples include resilient surface coverings, among others. These include polyvinylchloride (PVC) based as well as non-PVC based surface coverings. Non-PVC based surface coverings may include those based on polyolefin, polyester, or linoleum, among others. The surface may be any of a variety of different formats including sheet, tile, and plank, among others.

### Description of Weld Composition

The seam sealing “weld” compositions include those which are radiation curable, such as UV curable and include at least one acrylate-functionalized compound. Acrylate-functionalized compound includes at least one selected from polyester resins, epoxy resins, aliphatic urethanes, aromatic urethanes, silicones, polyethers, and combinations thereof.

As used herein, the term “(meth)acrylate” or “(meth)acrylic” refers to acrylate and/or methacrylate species. The (meth)acrylate” may include a single (meth)acrylate group or more than one (meth)acrylate group.

Suitable (meth)acrylate include polymerizable crosslinkable components which may be used in an amount of about 10 to about 90% by weight of the composition including about 80% by weight of the composition and about 10% to about 70% by weight of the composition. Suitable (meth)acrylates include ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopertyl glycoldiacrylate, pentaerythritol tetraacrylate, 1,2-butylene glycoldiacrylate, trimethylolpropane ethoxylate trimethacrylate, glyceryl propoxylate trimethacrylate, trimethylolpropane trimethacrylate, dipentaerythritol monohydroxy pentamethacrylate, tri(propylene glycol) dimethacrylate, neopentylglycol propoxylate dimethacrylate, 1,4-butanediol dimethacrylate, polyethyleneglycol dimethacrylate, triethylene glycol dimethacrylate, butylene glycol di(meth)acrylate, ethoxylated bisphenol A dimethacrylate and combinations thereof.

Other (meth)acrylates useful in some embodiments include those which conform to the structure:

H2C═CGCO2R

wherein G may be hydrogen, halogen or alkyl of 1 to about 4 carbon atoms, and R may be selected from alkyl, cycloalkyl, alkenyl, cycloalkenyl, alkaryl, aralkyl or aryl groups of 1 to about 16 carbon atoms, any of which may be optionally substituted or interrupted as the case may be with silane, silicon, oxygen, halogen, carbonyl, hydroxyl, ester, carboxylic acid, urea, urethane, carbamate, amine, amide, sulfur, sulfonate, sulfone and the like.

Examples of polar group functionalized (meth)acrylates include cyclohexylmethacrylate, hydroxyethyl acrylate, hydroxypropyl methacrylate, t-butylaminoethyl methacrylate, cyanoethylacrylate, and chloroethylmethacrylate. Other common monofunctional esters include alkyl esters such as lauryl methacrylate. Many lower molecular weight alkyl esters exhibit volatility, and frequently it may be more desirable to use a higher molecular weight homologue, such as decyl methacrylate or dodecyl methacrylate, or any other fatty acid acrylate esters, in (meth)acrylate-based impregnant compositions.

Hydroxyalkyl (meth)acrylates are also useful. The alkyl portion may be selected from numerous linear, branched or cyclic groups, e.g., having 1-20 carbon groups, which may also include various substitutions.

At least a portion of the (meth)acrylic monomer may include a di- or other (meth)acrylate ester. These multifunctional monomers produce cross-linked polymers, which serve as more effective and more durable sealants. Various (meth)acrylate monomers may be used.

Examples of these polymerizable (meth)acrylate esters include, but are not limited to, di-, tri- and tetraethyleneglycol dimethacrylate, dipropyleneglycol; dimethacrylate; polyethyleneglycol dimethylacrylate; di(pentamethyleneglycol) dimethacrylate; tetraethyleneglycol diacrylate; tetra-ethyleneglycol di(chloracrylate); diglycerol diacrylate; diglycerol tetramethacrylate; tetramethylene dimethacrylate; ethylene dimethacrylate; and neopentylglycol diacrylate. Others include, triethyleneglycol dimethacrylate, butyleneglycol dimethacrylate, bis(methacryloxyethyl) phosphate, 1,4 butane diol di(meth)acrylate and trimethylol propane dimethacrylate.

Specific (meth)acrylate monomers that may be included are isobornyl acrylate, N,N dimethyl acrylamide, isooctyl acrylate, isodecyl acrylate, 2(2-ethoxyethoxy)ethylacrylate, and combinations thereof. In one embodiment a combination of two or more monomers are included.

A variety of different additives are useful such as stabilizers, antioxidants, plasticizers, pigments, matting agents, curing agent, photoinitiators, free radical initiators, and combinations thereof. Additives may be included in any amount to effect the desired property. Suitable ranges for additives include about 1% to about 30% by weight of the composition.

Among the specific photoinitiators useful include acyl- or diacylphosphine oxide, such as diphenyl (2,4,6-trimethylbenzoyl)phosphine oxide 2,2 diethoxyacetophenone, benzyldimethyl ketal, 2,2-diethoxy-1,2-diphenylethanone, 1-hydroxy-cyclohexyl-phenyl ketone, α,α-dimethoxy-α-hydroxy acetophenone, 1-(4-isopropylphenyl)-2-hydroxy-2-methyl-propan-1-one, 1-[4-(2-hydroxyethoxy)phenyl]-2-hydroxy-2-methyl-propan-1-one, 2-methyl-1-[4-(methylthio)phenyl]-2-morpholino-propan-1-one, 2-benzyl-2-dimethylamino-1-(4-morpholinophenyl)-butan-1-one, 3,6-bis(2-methyl-2-morpholino-propanonyl)-9-butyl-carbazole, 4,4′-bis(dimethylamino)benzophenone, 2-chlorothioxanthone, 4-chlorothioxanthone, 2-isopropylthioxanthone, 4-isopropylthioxanthone, 2,4-dimethylthioxanthone, 2,4-diethylthioxanthone, 4-benzoyl-N,N-dimethyl-N-[2-(1-oxo-2-propenyl)oxy]ethylbenzenemethanaminium chloride, methyldiethanolamine, triethanolamine, ethyl 4-(dimethylamino)benzoate, 2-n-butoxyethyl 4-(dimethylamino)benzoate and combinations thereof. Desirably, the second photoinitiator is 2,2 diethoxyacetophenone.

Visible light photoinitiators may also be employed. Visible light photoinitiators include camphoroquinone peroxyester initiators, 9-fluorene carboxylic acid peroxyester initiators and alkyl thioxanthones, such as isopropyl thioxanthone.

A peroxide may be used as the free radical initiator of the composition. A number of well-known initiators of free radical polymerization may be incorporated in the present invention. Among those included are, without limitation, hydroperoxides, such as cumene hydroperoxide (CHP), paramenthane hydroperoxide, tertiary butyl hydroperoxide (TBH) and tertiary butyl perbenzoate. Useful amounts of peroxide compounds typically range from about 0.1 to about 10% by weight of the total composition. A reducing agent, such as saccharin may also be included.

Other additives such as moisture cure catalysts may be added in a conventional manner.

### Method

After the seam sealer composition is applied, there is an application of radiation, such as wavelengths in the range of infrared, visible, ultra-violet, and combinations thereof. The radiation source may be a lamp such as a UV lamp or LED. The composition may be cured by exposure to any radiation conditions that are curingly-effective for the composition. Suitable radiant energy types that may be usefully employed in the broad practice of some embodiments include electron beam radiation, ultraviolet radiation, visible light radiation, gamma radiation, X-rays, β-rays, etc. specific examples include the photocuring radiation of actinic radiation, i.e., electromagnetic radiation having a wavelength of about 700 nm or less that is capable of effecting cure of the silicone composition. Another suitable application of photocuring radiation includes ultraviolet (uv) radiation, e.g., from about 200 to about 540 nm.

Dual cure—moisture/energy—curing may also be employed.

### Kit

A kit for the application and installation of the seam sealing composition is also included. This may optionally include the curable composition in a dispensing cartridge, an applicator, a radiation source, UV glasses, dispensing tip for the cartridge, and a platform to ensure a uniform distance from the radiation source to the surface covering. One example of the platform is a cart including wheels to ease application of the radiation along the surface. The curable composition may be separate from the kit, such as where curable composition is in the cartridge. This is especially useful where the kit may be used with multiple installations and additional seam sealing composition is required.

The features and advantages of the present invention are more fully shown by the following examples which are provided for purposes of illustration and are not to be construed as limiting the invention in any way.

### EXAMPLES

### Water Infiltration Test

Materials
Flooring—non-PVC homogeneous sheet
3″ PVC pipe 2″ long
White Silicone Sealant
Water including dye

Method
Prep samples so there is a “T” seam using the sealant to be tested
   Side profile with an end profile
Place the PVC pipe centered over the T seam
Seal with silicone sealant
   Smooth out the silicone to ensure it has a tight seal
Allow sealant to fully cure
Add 30 mL of water to the PVP pipe
Observe the samples and not if water leaks through the sample or topical damage
Observations
Observe the samples and not if water leaks through the sample
   Types of Leaks
      Drip through the thickness of the product
      Surface leak (Water runs the edge of the profile and pools on the surface)
      Profile Leak (Water runs all the way through the profile and leaks out the end of the profile)
   Observations are to be made after starting the test
   10 minutes, 1 hour, 4 hours, 24 hours, 96 hours

Passing Test—After 24 hrs—No Visible Color Change/no liquid passing through the seam.

TABLE 1

| | | S-761 Seam | Non-PVC | Acylate |
|---|---|---|---|---|
| | | Adhesive | Weld Rod | based* - UV |
| | | (comparative) | (comparative) | cured (inventive) |
| 10 | min | Pass | Pass | Pass |
| 1 | hour | Pass | Pass | Pass |
| 4 | hours | Pass | Pass | Pass |
| 24 | Hours | Leak thru seam. No | Pass | Pass |
| | | surface pooling. All | | |
| | | liquid gone. | | |
| 96 | Hours | — | Pass | Pass |

| | | | |
|---|---|---|---|
| Results | Failure - <24 hours | Pass | Pass |

*QuickWeld ™ 29314 available from Armstrong Flooring

Table 1 demonstrates that the inventive installation including the UV cured acrylate based sealant met the need for preventing liquid from transferring from the surface to a subfloor.

### Seam Strength

Seam strength of the inventive sealing system was measured according to EN684. The results in Table 2 demonstrate that the seam met the standard of greater than 10 lbf/in.

TABLE 2

| Sample # | Maximum Load (lbf/in) | Load @ break (lbf/in) |
|---|---|---|
| 1 | 27.77 | 27.77 |
| 2 | 27.90 | 27.90 |
| 3 | 25.14 | 25.14 |
| Mean | 26.93 | 26.93 |

### Caster Wheel

Caster wheel strength was tested according to ISO 4918. Observation of the inventive sealing system was conducted at 5000, 10,000, and 15,000 revolutions. The inventive sealing system resisted damage at each interval.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

1. A method for sealing seams of resilient surface covering comprising applying a curable composition at a seam and applying radiation to the curable composition.

2. The method of claim 1, wherein the resilient surface covering comprises sheet flooring, tile flooring, or combinations thereof.

3. The method of claim 1, wherein the resilient surface covering comprises PVC.

4. The method of claim 1, wherein the resilient surface covering comprises a non-PVC composition.

5. The method of claim 1, wherein the radiation curable composition comprises an acrylate-functionalized compound.

6. The method of claim 1, wherein the acrylate-functionalized compound includes at least one selected from polyester resins, epoxy resins, aliphatic urethanes, aromatic urethanes, silicones, polyethers, and combinations thereof.

7. The method of claim 1, wherein the radiation curable composition comprises at least one additive selected from stabilizers, antioxidants, plasticizers, pigments, and combinations thereof

8. The method of claim 1, wherein the radiation is selected from those having a wavelength in the range of infrared, visible, ultra-violet, and combinations thereof

9. The method of claim 1, wherein the resilient surface covering is a floor or wall covering.

10. Installed flooring including sealed seams comprising resilient flooring and a radiation curable composition.

11. The installed flooring of claim 10, wherein the radiation curable composition is cured.

12. A kit for installing resilient surface covering comprising a curable composition in a dispensing cartridge, an applicator, and a radiation source, UV glasses, dispensing tip for the cartridge, and a platform to ensure a uniform distance from the radiation source to the surface covering.

13. The kit of claim 12, wherein the dispensing cartridge includes an application gun.

14. The kit of claim 12, wherein the radiation source is a light kit.

15. The kit of claim 12, where the platform comprises a cart.
